(19) United States
(12) Patent Application Publication
(10) Pub. No.: US 2013/0042523 A1
(43) Pub. Date: Feb. 21, 2013

(54) SYSTEM AND METHOD FOR CONTROLLING CULTIVATION OF PLANT IN GREENHOUSE

(71) Applicants: Sangho LEE, Daegu (KR); Jang sik BAE, Daegu (KR); Ae Kyeung MOON, Daejeon (KR); Song LI, Seongnam-si (KR); Hae Dong LEE, Daegu (KR); Kyuhyung KIM, Daegu (KR); Gwang Su KIM, Daejeon (KR)

(72) Inventors: Sangho LEE, Daegu (KR); Jang sik BAE, Daegu (KR); Ae Kyeung MOON, Daejeon (KR); Song LI, Seongnam-si (KR); Hae Dong LEE, Daegu (KR); Kyuhyung KIM, Daegu (KR); Gwang Su KIM, Daejeon (KR)

(73) Assignee: Electronics and Telecommunications Research Institute, Daejeon (KR)

(21) Appl. No.: 13/551,096

(22) Filed: Jul. 17, 2012

(30) Foreign Application Priority Data
Aug. 19, 2011 (KR) 10-2011-0082984

(51) Int. Cl. A01G 9/14

(52) U.S. Cl. 47/17

(57) ABSTRACT

A greenhouse plant cultivation control system includes a plurality of solar cell modules providing light of different wavelengths to each of a plurality of areas in which plants are cultivated, and a movement of a plant to an area in which light of a wavelength required for the plant is provided is determined according to a type of the plant and a growth stage of the plant.

### CROSS-REFERENCE TO RELATED APPLICATION

This application claims priority to and the benefit of Korean Patent Application No. 10-2011-0082984 filed in the Korean Intellectual Property Office on Aug. 19, 2011, the entire contents of which are incorporated herein by reference.

### BACKGROUND OF THE INVENTION

(a) Field of the Invention

The present invention relates to a system and method for controlling cultivation of a plant in a greenhouse and, more particularly, to a system and method for controlling cultivation of a plant in a greenhouse to effectively cultivate a plant according to a growth stage thereof.

(b) Description of the Related Art

A glass greenhouse or a vinyl greenhouse is widely used to promote the growth of a plant or restrain the growth of a plant, produce agricultural products throughout the year, or cultivate special farm produce which is not cultivated outdoors. The interior of a greenhouse is maintained to have a high temperature by solar heat in comparison to the outside, and since the light of the sun is mostly transmitted through glass or vinyl to reach plant bodies, an environment which is very advantageous for the growth of plants is established.

Meanwhile, growth environmental conditions differ according to types and growth stages of plants, and in order to increase the yield (or the crop) of plants, a growth environment should be appropriately controlled according to growth stages of plants. In general, growth stages of plants including crops may be divided into a germinating stage, a nutrition growth stage, a reproductive growth stage, and the like, and environment conditions such as soil, water, light, temperature, and the like, may differ in the respective growth stages.

Recently, it has been revealed that there is a difference in the growth of plants according to the wavelengths of solar light according to types of plants, growth stages, or the like, but, in actuality, the wavelengths of solar light are not controlled differently according to types of plants or growth stages in a greenhouse. Thus, in order to accelerate the growth of plants, it is required to control such that an appropriate light wavelength is absorbed according to types of plants or growth stages.

### SUMMARY OF THE INVENTION

The present invention has been made in an effort to provide a system and method for controlling cultivation of plants in a greenhouse having advantages of accelerating the growth of plants.

An exemplary embodiment of the present invention provides a system for controlling cultivation of plants cultivated in at least one greenhouse. The greenhouse plant cultivation controlling system includes a plurality of solar cell modules and a plant cultivation controller. The plurality of solar cell modules may be installed on outer walls of the greenhouse to correspond to a plurality of areas in which plants are cultivated, and provide light of different wavelengths to the respective areas. The plant cultivation controller may determine a movement of a plant to an area in which light of a wavelength required for the plant is provided according to a type of the plant and a growth stage of the plant.

The plant cultivation controller may include: a plant type determining unit configured to determine the type of the plant; a growth state collecting unit configured to determine a current growth stage of the plant; a wavelength determining unit configured to determine an optimum absorption wavelength currently required for the plant based on the type of the plant and the current growth stage of the plant; and a plant movement determining unit configured to compare the optimum absorption wavelength and the wavelength of an area in which the plant is cultivated, and determine a movement of the plant.

The plant cultivation controller may further include a growth region determining unit configured to determine a cultivation region of the plant, wherein the wavelength determining unit may determine the optimum absorption wavelength based on the cultivation region of the plant.

The plant cultivation controller may further include a database storing types of plants, cultivation region of plants, and maximum absorption wavelengths according to growth stages of plants, wherein the wavelength determining unit may determine the optimum absorption wavelength with reference to the database.

Each of the plurality of solar cell modules may be a dye-sensitized solar cell.

The plurality of solar cell modules may have different types of dyes.

Another embodiment of the present invention provides a method for controlling cultivation of a plant in a greenhouse plant cultivation control system. The greenhouse plant cultivation control method includes: providing light beams of different wavelengths to a plurality of areas in which plants are cultivated by a plurality of solar cell modules; determining a type and a growth stage of a plant cultivated in any one of the areas; determining an optimum absorption wavelength of the plant required for the type and growth stage of the plant; and comparing the optimum absorption wavelength and a wavelength provided to the any one area and determining a movement of the plant.

The determining of the optimum absorption wavelength may include: determining a cultivation region of the plant; and determining an optimum absorption wavelength required for the plant according to the cultivation region of the plant and the type and growth stage of the plant.

The determining of a movement of the plant may include: determining a movement of the plant to an area in which light of a wavelength corresponding to the optimum absorption wavelength is provided, when the optimum absorption wavelength is different from the wavelength provided in the any one area.

### BRIEF DESCRIPTION OF THE DRAWINGS

FIG. 1 is a view illustrating a greenhouse plant cultivation control system according to an embodiment of the present invention.

FIG. 2 is a view illustrating a plant cultivation controller illustrated in FIG. 1.

FIG. 3 is a flowchart illustrating an operation of the plant cultivation controller illustrated in FIG. 2.

FIG. 4 is a view illustrating an example of determining types of plants and/or cultivation region.

FIG. 5 is a view illustrating another example of installation of a plurality of solar cell modules.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

A greenhouse plant cultivation control system and method according to embodiments of the present invention will be described in detail with reference to the accompanying drawings.

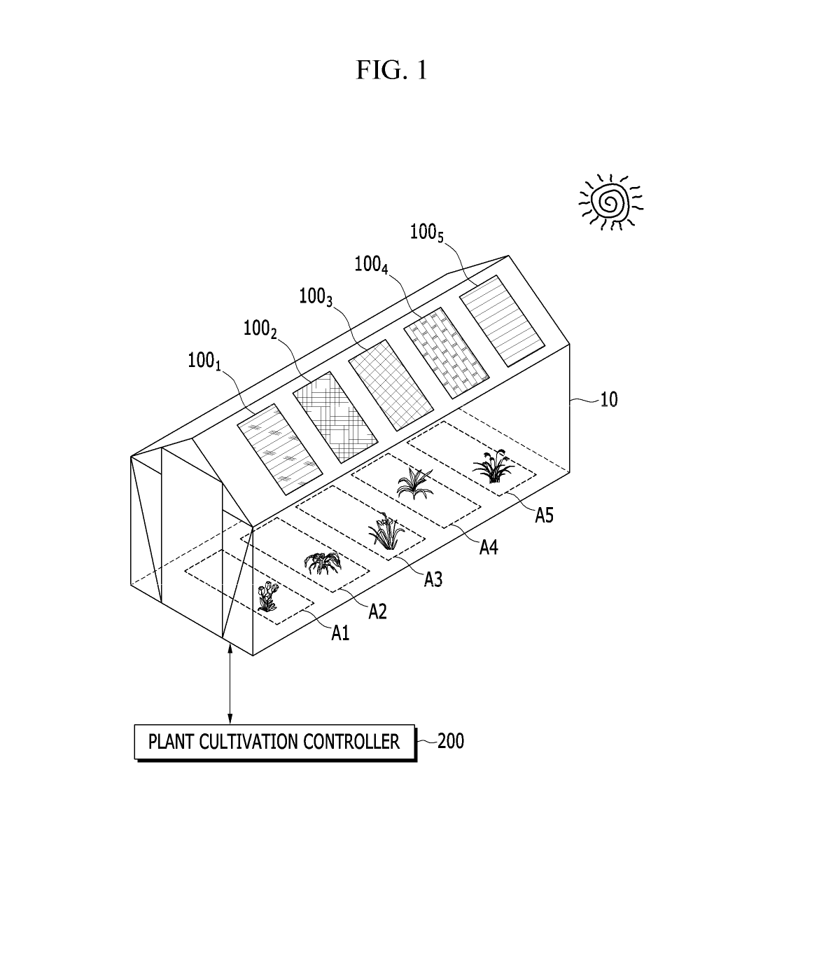

FIG. 1 is a view illustrating a greenhouse plant cultivation control system according to an embodiment of the present invention.

With reference to FIG. 1, the greenhouse plant cultivation control system includes a plurality of solar cell modules, e.g., solar cell modules 100₁, 100₂, 100₃, 100₄, and 100₅ and a plant cultivation controller 200.

The solar cell modules 100₁, 100₂, 100₃, 100₄, and 100₅ are installed on an outer wall such as the roof of a greenhouse 10, and correspond to areas A₁, A₂, A₃, A₄, and A₅ in which plants are cultivated, respectively.

The solar cell modules 100₁, 100₂, 100₃, 100₄, and 100₅ transmit and reflect only a particular wavelength of solar light, and solar light of remaining wavelengths which have not been transmitted or reflected is used to generate power. The solar cell modules 100₁, 100₂, 100₃, 100₄, and 100₅ transmit different wavelengths, respectively. Thus, the plants cultivated in the respective areas A₁, A₂, A₃, A₄, and A₅ of the greenhouse absorb different wavelengths of solar light because of the corresponding solar cell modules 100₁, 100₂, 100₃, 100₄, and 100₅.

The plants using a wavelength provided by the solar cell modules 100₁, 100₂, 100₃, 100₄, and 100₅ as an optimum absorption wavelength may be cultivated in respective areas. Also, the same type of plants may be cultivated in the respective areas A₁, A₂, A₃, A₄, and A₅. When the same type of plants are cultivated in the respective areas A₁, A₂, A₃, A₄, and A₅, the plants in a growth stage using the wavelength provided by the solar cell modules 100₁, 100₂, 100₃, 100₄, and 100₅ as an optimum absorption wavelength may be cultivated in the respective areas A₁, A₂, A₃, A₄, and A₅.

A dye-sensitized solar cell may be used as the solar cell modules 100₁, 100₂, 100₃, 100₄, and 100₅.

The dye-sensitized solar cell may include a solar light-transmissive transparent electrode coated on a transparent substrate, a catalytic counter electrode, a dye polymer coated on a surface of nano-particles attached to the transparent electrode, and an oxidizing/reducing solution filling a space between the transparent electrode and the counter electrode.

When solar light is made incident to the dye-sensitized solar cell, reflection primarily occurs from the transparent substrate, and in this case, ultraviolet (UV) rays or the like having a short wavelength and substantially failing to pass through the transparent substrate are reflected, and only a wavelength of a visible light region reaches the dye polymer. Subsequently, a portion of visible light is secondarily reflected from and absorbed into the surface of the dye polymer, while the remaining portion passes through the dye polymer. The light of the absorbed wavelength excites electrons of the dye polymer to generate electrons, and the generated electrons move to the outside through the transparent electrode to transfer electrical energy, and the dye polymer oxidized by the solar light absorption again receives electrons through an electrolytic solution so as to be reduced to the original state. The dye-sensitized solar cell repeatedly performs the foregoing process to eventually produce electricity. In this process, light of a particular wavelength is absorbed while light of the remaining wavelength regions is reflected and transmitted according to types of dyes. As a result, in fabricating a dye-sensitized solar cell, wavelengths to be reflected, absorbed, and transmitted are determined according to what kind of dyes are used. Thus, when the dye-sensitized solar cells are used as the solar cell modules 100₁, 100₂, 100₃, 100₄, and 100₅, the solar cell modules 100₁, 100₂, 100₃, 100₄, and 100₅ may use different types of dyes to provide light having different wavelengths.

In general, plants including crops have a photoreception pigment for adjusting a growth stage of plants in response to a wavelength of incident light. The photoreception pigment involved in the growth stages of plants may include, for example, chlorophyll, carotenoids, anthocyanins, phytochrome, and the like. A maximum absorption wavelength of the photoreception pigment is 430 nm and 662 nm-664 nm in case of chlorophyll a, and 453 nm-460 nm and 642 nm-647 nm in case of chlorophyll b. Cartenoids have a maximum absorption wavelength of about 430 nm-500 nm and 640 nm-660 nm, and in case of phytochrome, a maximum absorption wavelength of Pf (bluish green) is about 650 nm-670 nm and Pfr (green) is about 705 nm-740 nm. A maximum absorption wavelength of anthocyanins is about 530 nm-540 nm. In this manner, the maximum absorption wavelengths are different according to growth stages.

Also, there are various growth change patterns according to cultivated plants. For example, in case of lettuce, only nutrition growth is preferentially required after seed germination. The reason is because, when lettuce enters reproductive growth to have a rachis, the value of the lettuce as a commodity is lost. However, in case of red leaf lettuce, manifestation (or revelation) of anthocyanins through chlorophyll destruction by the irradiating UV-A ultraviolet region is required. In contrast, in case of fruit vegetables, reproductive growth is required after nutrition growth for a period of time. Also, for color manifestation of fruits, sufficient irradiation of the UV-A ultraviolet region is required before shipment (or before coming onto the market).

In this manner, the maximum absorption wavelengths required for plants are different according to the types of cultivated plants and the growth stages of the plants.

The plant cultivation controller 200 serves to provide light of appropriate wavelengths to corresponding plants according to the types of the plants and the growth stages of the plants in the greenhouse 10 with the solar cell modules 100₁, 100₂, 100₃, 100₄, and 100₅ installed thereon.

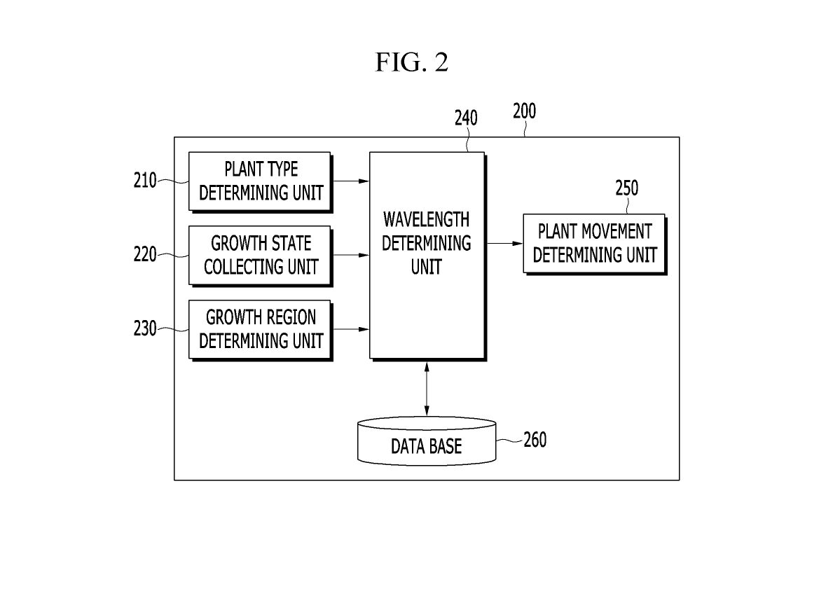

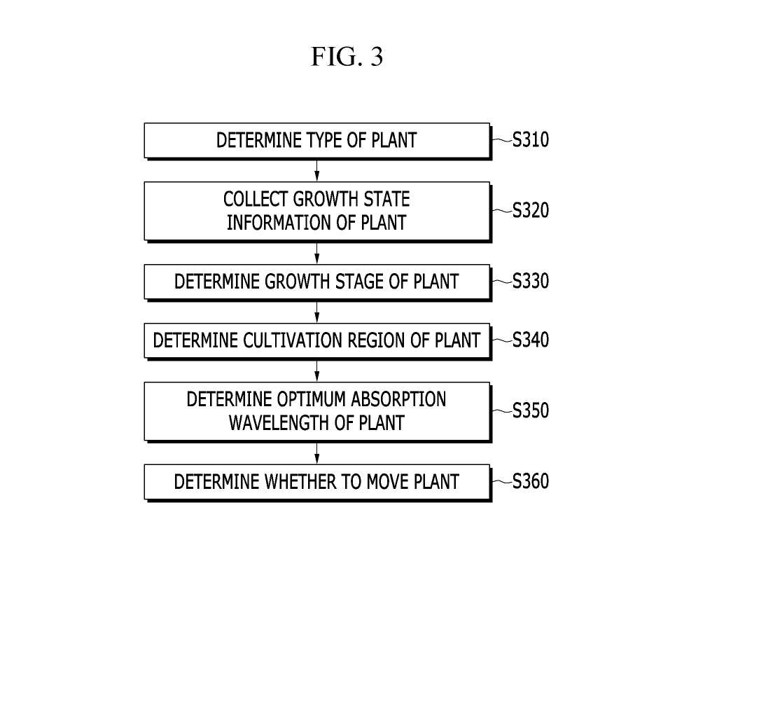

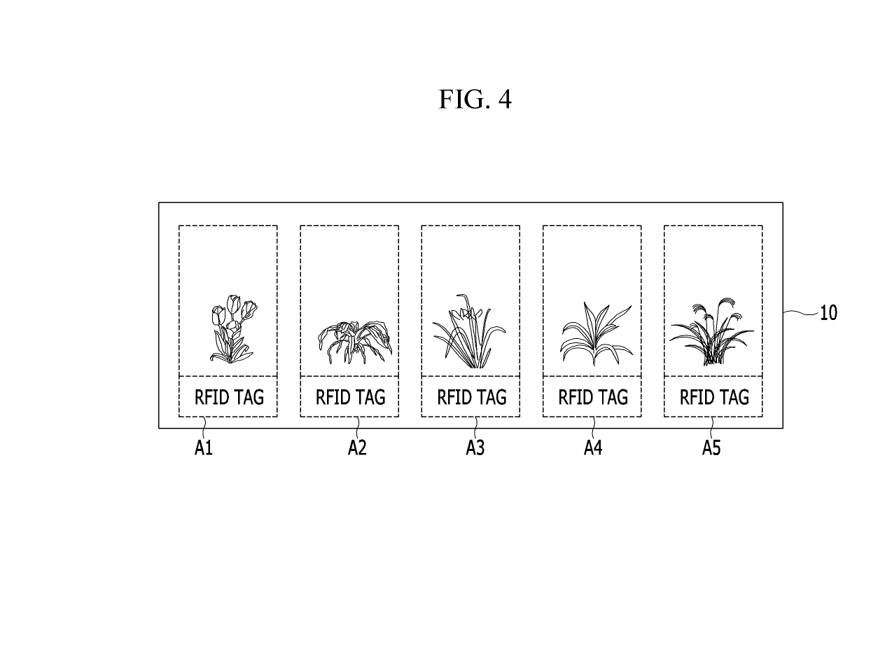

FIG. 2 is a view illustrating a plant cultivation controller illustrated in FIG. 1, and FIG. 3 is a flowchart illustrating an operation of the plant cultivation controller illustrated in FIG. 2. FIG. 4 is a view illustrating an example of determining types of plants and/or cultivation region.

First, as described above with reference to FIG. 1, the plurality of solar cell modules 100₁, 100₂, 100₃, 100₄, and 100₅ providing light of particular wavelengths to the respective regions A₁, A₂, A₃, A₄, and A₅ within the greenhouse 10 are installed on an outer wall such as the roof of the greenhouse 10.

With reference to FIG. 2, the plant cultivation controller 200 includes a plant type determining unit 210, a growth state collecting unit 220, a growth region determining unit 230, a wavelength determining unit 240, a plant movement determining unit 250, and a database 260.

The plant type determining unit 210 determines types of plants cultivated in the respective areas in the greenhouse 10 (S310).

As shown in FIG. 4, an RFID tag corresponds to a tag identifier, and stores information regarding a type of a plant to which the RFID tag is to be attached. The RFID tag may be attached to at least one plant cultivated in each area. When such an RFID tag is attached to corresponding plants, the plant type determining unit 210 may determine types of plants cultivated in the respective areas through communication with the RFID tag. Alternatively, the plant type determining unit 210 may receive information regarding types of plants from a user to determine the types of the plants.

The plant type determining unit 210 transfers information regarding the type of plant to the wavelength determining unit 240.

The growth state collecting unit 220 collects information regarding a growth state of the plants cultivated in the respective areas in the greenhouse 10 (S320), determines a current growth stage of each plant based on the collected plant growth state information (S330), and transfers information regarding the growth stages of the plants to the wavelength determining unit 240. The growth state collecting unit 220 may include a sensor, or the like, for sensing the number of leaves, size, and the like, of the plants, and may determine current growth stages of the plants based on the information regarding the number of leave, size, and the like, of the plants. Here, as shown in FIG. 4, when the RFID tags are attached to the plants cultivated in the respective areas, information regarding the current growth stages of the plant corresponding to the tag identifiers may be transferred to the wavelength determining unit 240.

The growth region determining unit 230 determines cultivation region of the plants (S340).

The RFID tag illustrated in FIG. 4 may store information regarding a type of plant to which the RFID tag is to be attached according to a tag identifier, and information regarding a cultivation region of the corresponding plant. In this case, the growth region determining unit 230 may determine a cultivation region of the plant through communication with the RFID tag. Alternatively, the growth region determining unit 230 may determine a cultivation region of the plant upon receiving information regarding the cultivation region of the plant from the user. The growth region determining unit 230 transfers the information regarding the cultivation region of the plant to the wavelength determining unit 240.

The wavelength determining unit 240 determines an optimum absorption wavelength currently required for the plant based on the information regarding the type of the plant cultivated in the greenhouse, the information regarding the cultivation region of the plant, and the current growth stage of the plant (S350). The optimum absorption wavelength may be a maximum absorption wavelength.

The plant movement determining unit 250 may compare a wavelength provided to the area in which the corresponding plant is present and the maximum absorption wavelength determined by the wavelength determining unit 240 to determine whether to move the plant (S360). When the wavelength provided to the area in which the corresponding plant is present is different from the maximum absorption wavelength determined by the wavelength determining unit 240, the plant movement determining unit 250 determines a movement of the plant, and in this case, the plant movement determining unit 250 may determine to move the corresponding plant to an area in which the maximum absorption wavelength determined by the wavelength determining unit 240 is provided.

Meanwhile, when the wavelength provided to the area in which the corresponding plant is currently cultivated is equal or similar to the maximum absorption wavelength determined by the wavelength determining unit 240, the plant movement determining unit 250 determines not to move the corresponding plant. In this case, the similarity of wavelength may refer to a case in which a band of the maximum absorption wavelength overlaps by at least 80% or more with a band of the wavelength provided in the area in which the corresponding plant is currently cultivated.

When the plant movement determining unit 250 determines to move the plant, the plant movement determining unit 250 may move the plant to the corresponding area. The plant movement determining unit 250 may include a moving unit (not shown) for moving the plant. Alternatively, when the plant movement determining unit 250 determines to move the plant, the plant may be moved to the corresponding area manually by an operator.

The database 260 stores types of the plants, cultivation region of the plants, and maximum absorption wavelengths according to growth stages of the plants.

In this manner, the plant cultivation controller 200 according to an embodiment of the present invention provides light of an appropriate wavelength according to types and growth stages of the cultivated plants.

Thus, when the greenhouse plant cultivation control system is used, various types of plants can be simultaneously cultivated while providing light of appropriate wavelengths.

Meanwhile, in the present embodiment, it has been described that the single greenhouse 10 is partitioned into a plurality of areas A, A₂, A₃, A₄, and A₅ and the plurality of solar cell modules 100₁, 100₂, 100₃, 100₄, and 100₅ which transmit different wavelengths correspondingly according to the respective areas A, A₂, A₃, A₄, and A₅ are installed, but the present invention may be embodied in a different manner.

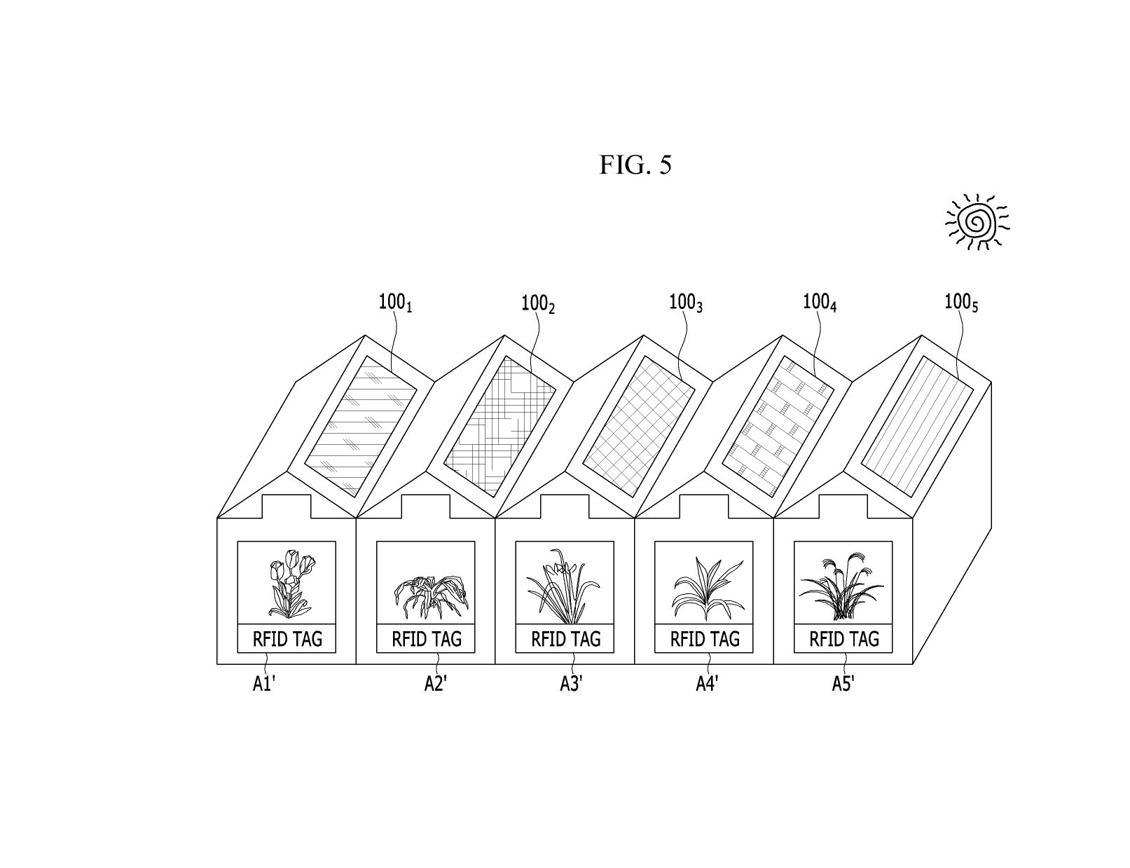

FIG. 5 is a view illustrating another example of installation of a plurality of solar cell modules.

As shown in FIG. 5, a single greenhouse may be used as a single area as a whole. Namely, solar cell modules 100₁, 100₂, 100₃, 100₄, and 100₅ which transmit different wavelengths, respectively, may be installed on a plurality of greenhouses A₁′, A₂′, A₃′, A₄′, and A₅′, respectively.

When the solar cell modules 100₁, 100₂, 100₃, 100₄, and 100₅ which transmit different wavelengths, respectively, are installed on the plurality of greenhouses A₁′, A₂′, A₃′, A₄′, and A₅′, the plant cultivation controller 200 determines a movement of each plant to a greenhouse providing an optimum wavelength according to the type and the growth stage of each plant.

According to an embodiment of the present invention, since light of an appropriate wavelength is provided according to types and growth stages of cultivated plants, the growth of plants can be accelerated and the crop of plants can also be increased.

The embodiments of the present invention may not necessarily be implemented only through the foregoing devices and/or methods, but may also be implemented through a program for realizing functions corresponding to the configurations of the embodiments of the present invention, a recording medium including the program, or the like, and such an implementation may be easily made by a skilled person in the art to which the present invention pertains from the foregoing description of the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A greenhouse plant cultivation control system for controlling cultivation of plants cultivated in at least one greenhouse, comprising:
a plurality of solar cell modules installed on outer walls of the greenhouse corresponding to a plurality of areas in which plants are cultivated, and providing light of different wavelengths to the respective areas; and
a plant cultivation controller determining a movement of a plant to an area in which light of a wavelength required for the plant is provided according to a type of the plant and a growth stage of the plant.

2. The greenhouse plant cultivation control system of claim 1, wherein the plant cultivation controller comprises:
a plant type determining unit configured to determine the type of the plant;
a growth state collecting unit configured to determine a current growth stage of the plant;
a wavelength determining unit configured to determine an optimum absorption wavelength currently required for the plant based on the type of the plant and the current growth stage of the plant; and
a plant movement determining unit configured to compare the optimum absorption wavelength and the wavelength of an area in which the plant is cultivated, and determine a movement of the plant.

3. The greenhouse plant cultivation control system of claim 2, wherein the plant cultivation controller further comprises
a growth region determining unit configured to determine a cultivation region of the plant,
wherein the wavelength determining unit determines the optimum absorption wavelength based on the cultivation region of the plant.

4. The greenhouse plant cultivation control system of claim 2, wherein the plant cultivation controller further comprises
a database storing types of plants, cultivation region of plants, and maximum absorption wavelengths according to growth stages of plants,
wherein the wavelength determining unit determines the optimum absorption wavelength with reference to the database.

5. The greenhouse plant cultivation control system of claim 2, wherein a plurality of RFID tags storing information regarding types of plants cultivated in the plurality of areas are installed in the plurality of areas, respectively, and
the plant type determining unit determines the type of the plant through communication with the plurality of RFID tags.

6. The greenhouse plant cultivation control system of claim 1, wherein each of the plurality of solar cell modules is a dye-sensitized solar cell.

7. The greenhouse plant cultivation control system of claim 6, wherein the plurality of solar cell modules have different types of dyes.

8. A method for controlling cultivation of a plant in a greenhouse plant cultivation control system, the method comprising:
providing light beams of different wavelengths to a plurality of areas in which plants are cultivated by a plurality of solar cell modules;
determining a type and a growth stage of a plant cultivated in any one of the areas;
determining an optimum absorption wavelength of the plant required for the type and growth stage of the plant; and
comparing the optimum absorption wavelength and a wavelength provided to the any one area and determining a movement of the plant.

9. The method of claim 8, wherein the determining of the optimum absorption wavelength comprises:
determining a cultivation region of the plant; and
determining an optimum absorption wavelength required for the plant according to the cultivation region of the plant and the type and growth stage of the plant.

10. The method of claim 8, wherein the determining of a movement of the plant comprises
determining a movement of the plant to an area in which light of a wavelength corresponding to the optimum absorption wavelength is provided, when the optimum absorption wavelength is different from the wavelength provided in the any one area.

11. The method of claim 8, further comprising,
when a movement of the plant is determined, moving the plant.

12. The method of claim 8, wherein each of the plurality of solar cell modules is a dye-sensitized solar cell.

13. The method of claim 12, wherein the plurality of solar cell modules have different types of dyes.
